(19) United States
(12) Patent Application Publication
(10) Pub. No.: US 2026/0145336 A1
(43) Pub. Date: May 28, 2026

(54) VERTICAL ARTICULATED ROBOT AND ROBOT SYSTEM

(71) Applicant: SEIKO EPSON CORPORATION, Tokyo (JP)

(72) Inventors: Daisuke KOMATSU, SUWA-SHI (JP); Hikaru HIRAMOTO, MATSUMOTO-SHI (JP)

(21) Appl. No.: 19/400,909

(22) Filed: Nov. 25, 2025

(30) Foreign Application Priority Data
Nov. 26, 2024 (JP) 2024-205236

(51) Int. Cl. B25J 9/16; B25J 18/00

(52) U.S. Cl. CPC B25J 9/1694; B25J 18/00

(57) ABSTRACT

A vertical articulated robot includes a base, a first drive mechanism connected to the base, a first arm connected to the first drive mechanism and configured to rotate about a rotation axis, a second drive mechanism connected the first arm, a second arm connected to the second drive mechanism, and a motor configured to drive the second arm, the first arm includes a first housing connected to the first drive mechanism, a second housing fixed to the first housing and connected to the second drive mechanism, and an inertial sensor module fixed to the first housing and configured to detect at least one parameter selected from acceleration and angular velocity of the first arm, and the motor is fixed to the second housing or the second arm.

### CROSS-REFERENCE TO RELATED APPLICATIONS

The present application is based on, and claims priority from JP Application Serial Number 2024-205236, filed November 26, 2024, the disclosure of which is hereby incorporated by reference herein in its entirety.

### BACKGROUND OF THE INVENTION

### 1. Technical Field

The present disclosure relates to a vertical articulated robot and a robot system.

### 2. Related Art

JP-A-2014-205198 discloses a configuration of a robot in which a first angular velocity sensor functioning as an inertial sensor is disposed in a first arm. Specifically, the inertial sensor is fixed to a housing connected to a motor and a joint.

However, in the configuration described in JP-A-2014-205198, since the inertial sensor is fixed to the housing connected to the motor and the like, there is a problem in that the vibration of the motor and the like is easily transmitted to the inertial sensor, and the detection accuracy is low.

### SUMMARY OF THE INVENTION

A vertical articulated robot includes: a proximal member; a first joint connected to the proximal member; an arm connected to the first joint and configured to rotate about a first rotation axis; a second joint connected to the arm; a distal member connected to the second joint; and a motor configured to drive the distal member, the arm includes a first housing connected to the first joint, a second housing fixed to the first housing and connected to the second joint, and an inertial sensor fixed to the first housing and configured to detect at least one parameter selected from acceleration and angular velocity of the arm, and the motor is fixed to the second housing or the distal member.

A robot system includes: the vertical articulated robot described above; and a control device that performs arithmetic processing for the inertial sensor.

### BRIEF DESCRIPTION OF DRAWINGS

FIG. 1 is a schematic diagram illustrating the configuration of a robot system.

FIG. 2 is a perspective view illustrating the configuration of a vertical articulated robot.

FIG. 3 is an enlarged perspective view illustrating the portion III of the vertical articulated robot illustrated in FIG. 2.

FIG. 4 is an exploded perspective view illustrating the configuration of a first arm.

FIG. 5 is an exploded perspective view illustrating the configuration of a first housing.

FIG. 6 is a perspective view illustrating the internal structure of the first arm.

FIG. 7 is a plan view illustrating the configuration of the first arm.

FIG. 8 is a perspective view illustrating the configuration of the first arm.

FIG. 9 is a perspective view illustrating the configuration of the first arm.

FIG. 10 is a side view illustrating the configuration of the first arm.

FIG. 11 is a side view illustrating the configuration of the first arm.

FIG. 12 is a side view illustrating the configuration of the first arm.

FIG. 13 is a side view illustrating the configuration of the first arm.

### DETAILED DESCRIPTION OF THE INVENTION

Hereinafter, the configuration of a vertical articulated robot 1 and the configuration of a robot system 1000 will be described with reference to the drawings. In each of the following figures, three axes orthogonal to each other are referred to as an X-axis, a Y-axis, and a Z-axis. A direction along the X-axis is referred to as an "X direction", a direction along the Y-axis is referred to as a "Y direction", and a direction along the Z-axis is referred to as a "Z direction". An arrow direction is referred to as a + direction, and a direction opposite to the + direction is referred to as a - direction. A view from the +Z direction or the -Z direction is referred to as a plan view or planar.

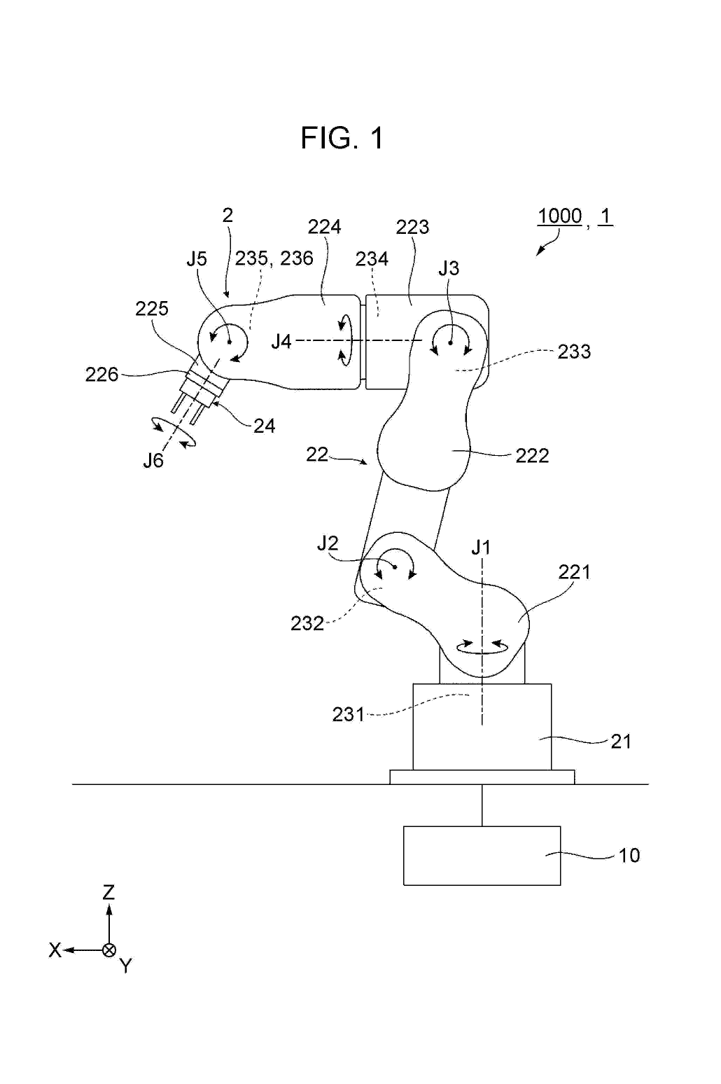

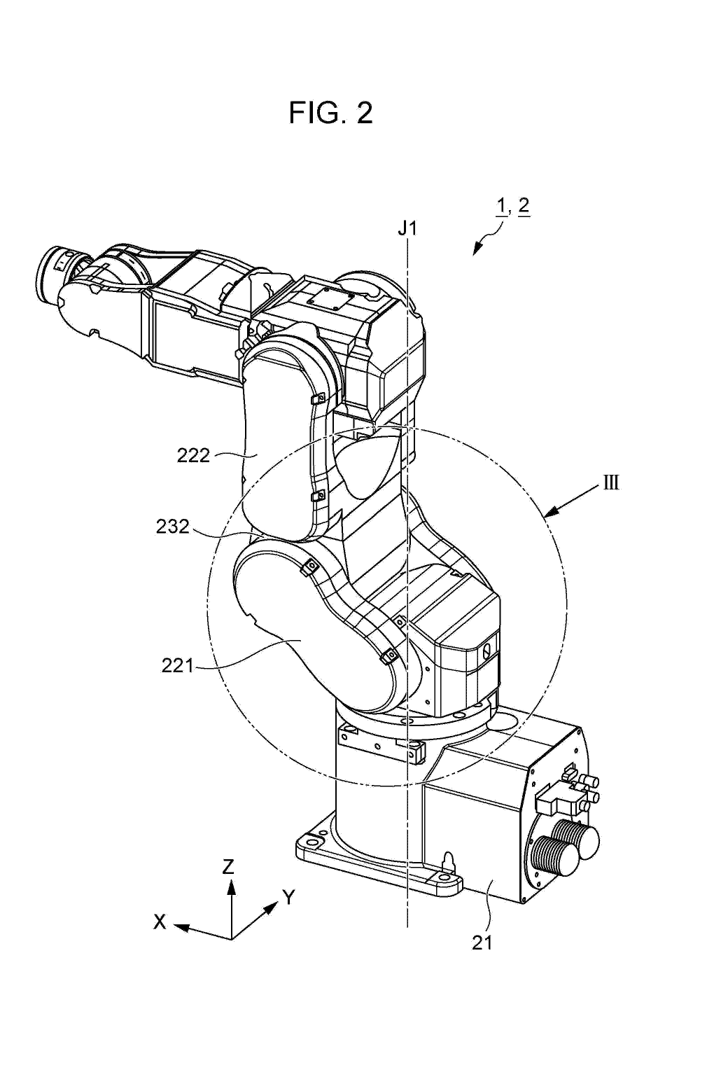

First, the configuration of the robot system 1000 will be described with reference to FIGS. 1 and 2.

As illustrated in FIGS. 1 and 2, the robot system 1000 includes a robot main body 2 as the vertical articulated robot 1, and a controller 10 as a control device that controls driving of the robot main body 2.

The vertical articulated robot 1 is, for example, a six-axis robot having six drive axes. The vertical articulated robot 1 includes a base 21 as a proximal member fixed to a floor and a robot arm 22 connected to the base 21.

The robot arm 22 includes a first arm 221 as an arm, a second arm 222 as a distal member, a third arm 223, a fourth arm 224, a fifth arm 225, and a sixth arm 226.

The first arm 221 is connected to the base 21 via a first drive mechanism 231 as a first joint. The first arm 221 rotates about a rotation axis J1 as a first rotation axis with respect to the base 21. The first arm 221 is connected to the second arm 222 via a second drive mechanism 232 as a second joint. The second arm 222 rotates about a rotation axis J2 with respect to the first arm 221.

The third arm 223 is connected to the second arm 222 and rotates about a rotation axis J3 with respect to the second arm 222. The fourth arm 224 is connected to the third arm 223 and rotates about a rotation axis J4 with respect to the third arm 223. The fifth arm 225 is connected to the fourth arm 224 and rotates about a rotation axis J5 with respect to the fourth arm 224. The sixth arm 226 is connected to the fifth arm 225 and rotates about a rotation axis J6 with respect to the fifth arm 225. An end effector 24 is connected to the distal end of the sixth arm 226.

The robot main body 2 includes the first drive mechanism 231, the second drive mechanism 232, a third drive mechanism 233, a fourth drive mechanism 234, a fifth drive mechanism 235, and a sixth drive mechanism 236.

The first drive mechanism 231 rotates the first arm 221 about the rotation axis J1 with respect to the base 21. The second drive mechanism 232 rotates the second arm 222 about the rotation axis J2 with respect to the first arm 221. The third drive mechanism 233 rotates the third arm 223 about the rotation axis J3 with respect to the second arm 222. The fourth drive mechanism 234 rotates the fourth arm 224 about the rotation axis J4 with respect to the third arm 223. The fifth drive mechanism 235 rotates the fifth arm 225 about the rotation axis J5 with respect to the fourth arm 224. The sixth drive mechanism 236 rotates the sixth arm 226 about the rotation axis J6 with respect to the fifth arm 225.

The first drive mechanism 231 has a hollow speed reducer and a pulley provided on a hollow input shaft of the speed reducer. The pulley is connected to a motor provided in the base via a belt. The input shaft of the speed reducer has a hollow center. A sleeve for protecting a cable 630 from contact with the speed reducer passes through the hollow portion. The cable 630 described later enters the inside of the first arm 221 from the inside of the base 21 through the sleeve which is hollow.

The controller 10 controls each of the drive mechanisms 231 to 236 independently and causes the robot main body 2 to perform predetermined operations. The controller 10 includes a computer, which includes, for example, a processor that processes information, a memory that is communicably connected to the processor, and an external interface. The memory stores various programs that can be executed by the processor. The processor can read and execute the various programs and the like stored in the memory. Further, the controller 10 controls arithmetic processing for an inertial sensor module 600 described later.

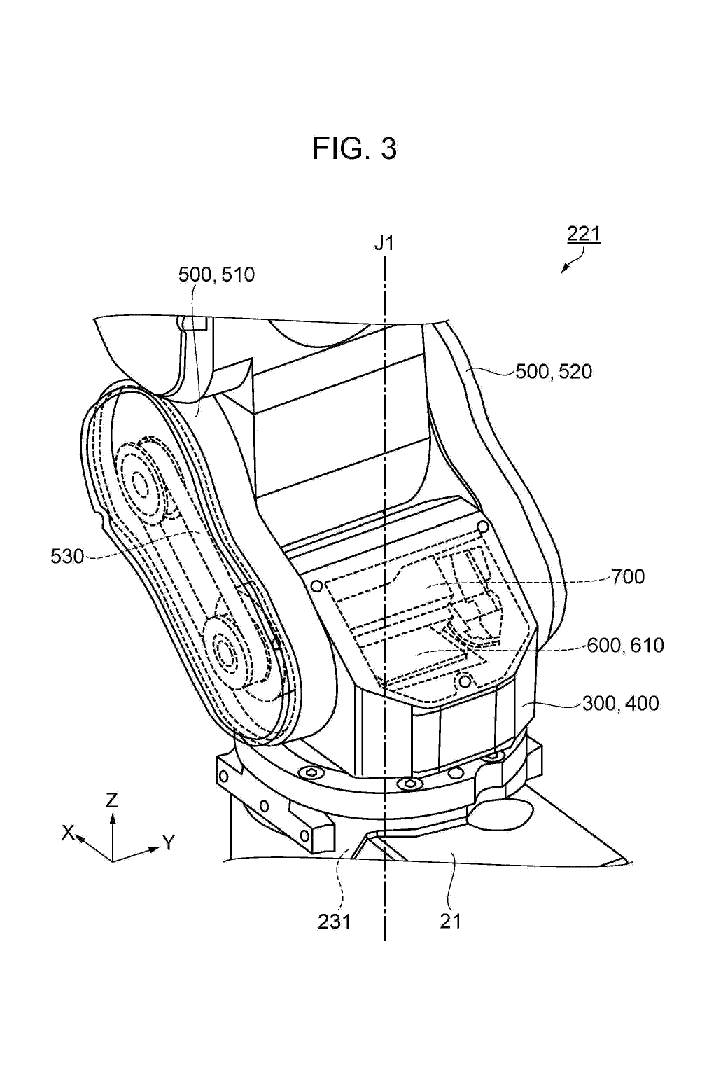

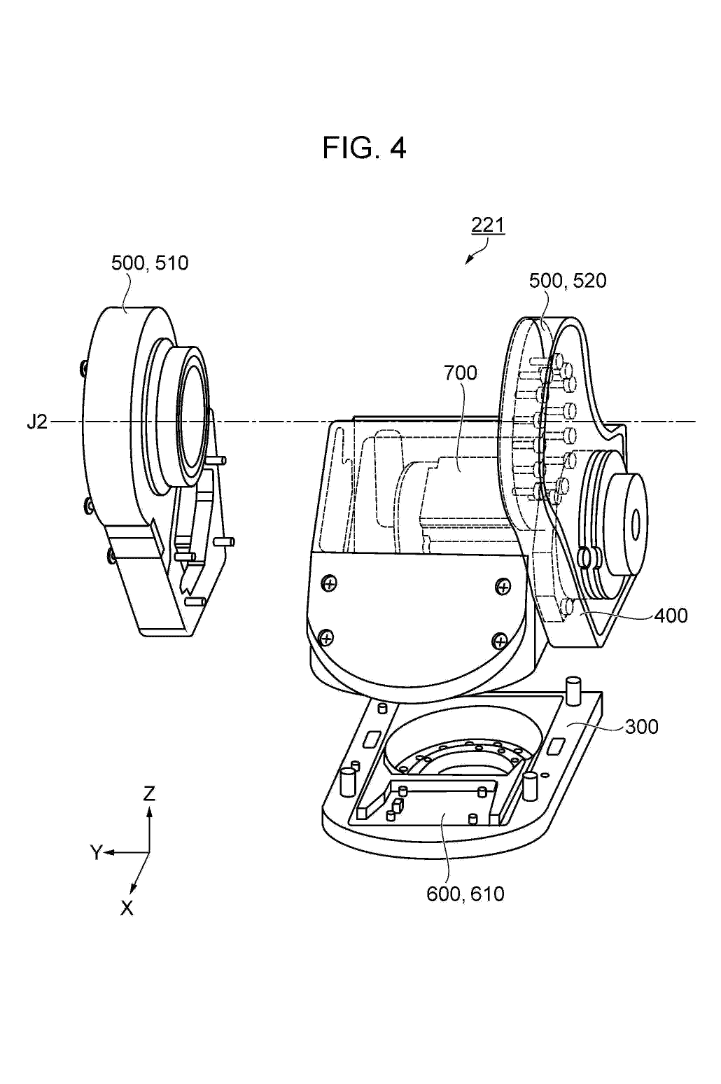

Next, the configuration of the first arm 221 will be described with reference to FIGS. 3 and 4.

As illustrated in FIGS. 3 and 4, the first arm 221 is connected to the base 21 via the first drive mechanism 231. As described above, the first arm 221 rotates about the rotation axis J1.

As illustrated in FIG. 4, the first arm 221 includes a first housing 300 and a second housing 400.

The first housing 300 is connected to the first drive mechanism 231 and has a plate shape extending in the directions intersecting, in the present embodiment, orthogonal to, the rotation axis J1. The first housing 300 is fixed to the second housing 400 by using, for example, pins or fixing screws. The second housing 400 is connected to the second drive mechanism 232.

The second housing 400 is mounted on the plate-like first housing 300 and extends toward the second arm 222 which is a distal member. In the present embodiment, the second housing 400 has support portions 500 extending upward. In the present embodiment, the second housing 400 is provided with an internal space for housing a motor 700.

A sensor substrate 610 is fixed to the first housing 300. The inertial sensor module 600 detects at least one parameter selected from the acceleration and the angular velocity of the first arm 221. The second housing 400 is provided with the support portions 500 having the rotation axis J2, and the motor 700 configured to drive the second arm 222 is fixed to the second housing 400. The motor 700 is disposed in the second housing 400 in a posture in which the rotational shaft of the motor 700 is parallel to the rotation axis J2. The motor 700 is not limited to being fixed to the second housing 400, and may be fixed to the second arm 222.

The inertial sensor module 600 includes the sensor substrate 610 and an angular velocity sensor 611 as an inertial sensor which is mounted on the sensor substrate 610 and detects the angular velocity about the vertical axis of the first arm 221. The inertial sensor of the present embodiment is mounted on the sensor substrate 610 so as to be suspended from the sensor substrate 610.

In addition, the angular velocity sensor 611 has a package, and an angular velocity sensor element and circuit elements which are housed in the package. The angular velocity sensor element is, for example, a quartz crystal oscillator. The angular velocity sensor element includes a drive arm which is driven and vibrated by application of a drive signal, and a detection arm which is vibrated by detection of a Coriolis force generated when an angular velocity is applied, and outputs a signal having a magnitude corresponding thereto. In addition, the circuit elements include, for example, a drive circuit which vibrates the drive arm of the quartz crystal oscillator by applying a drive signal, and a detection circuit which detects the angular velocity based on a signal output from the detection arm.

Since the inertial sensor module 600 is disposed in the first arm 221, it acquires vibration data in the vicinity of the first arm 221, specifically, in the direction of rotation about the rotation axis J1, and suppresses the vibration of the first arm 221 based on the vibration data. The inertial sensor module 600 is not limited to being disposed in the first arm 221, and may be disposed in another arm.

In addition, a control circuit which controls driving of the angular velocity sensor 611 based on a command from the controller 10 is formed on the sensor substrate 610. The control circuit includes a central processing unit (CPU), a read only memory (ROM), and the like, and the above-described function is achieved by the CPU reading and executing a program or data stored in the ROM. The control circuit acquires a signal from the angular velocity sensor 611 and sends the signal to the controller 10.

The inertial sensor may be, for example, an acceleration sensor that detects the acceleration along at least one of the X-axis and the Y-axis, or a composite sensor that detects both the acceleration and the angular velocity. In a case of using a composite sensor, the inertial sensor module 600 may be an inertial measurement unit (IMU). In addition, the angular velocity sensor element is a quartz crystal oscillator in the present embodiment, but is not limited thereto and may be, for example, a silicon MEMS that detects the angular velocity based on changes in capacitance between a movable electrode and a fixed electrode.

In addition, in a case where the IMU is used as the inertial sensor module 600, it is necessary to horizontally install the IMU. However, since it is possible to secure a space for maintaining the horizontality by disposing the IMU in the first housing 300, it is possible to effectively use the IMU for detection.

In this manner, since the inertial sensor module 600 is fixed to the first housing 300 and the motor 700 is fixed to the second housing 400 or the second arm 222, the inertial sensor module 600 and the motor 700 which is a vibration source are not fixed to the same housing. Therefore, it is possible to prevent the vibration of the motor 700 from being directly transmitted to the inertial sensor module 600, and to suppress the influence of the vibration. Thus, it is possible to improve the detection accuracy of the inertial sensor module 600.

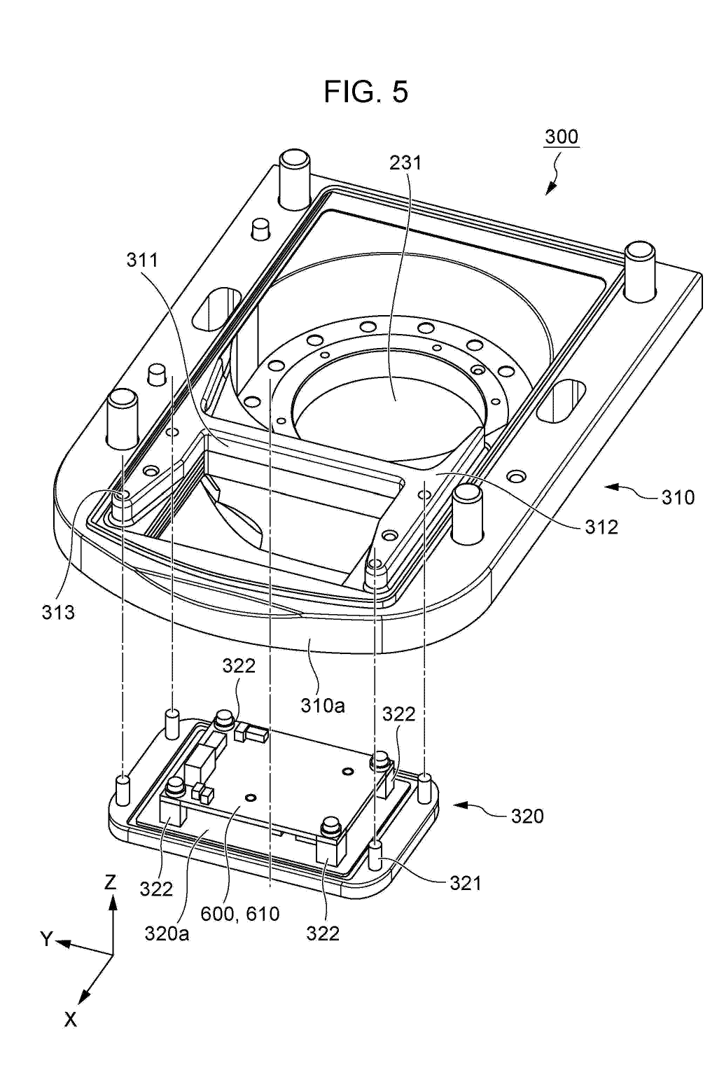

Next, the configuration of the first housing 300 will be described with reference to FIG. 5.

As illustrated in FIG. 5, the first housing 300 has a first portion 310 disposed on the second housing 400 side, in other words, connected to the second housing 400. The first housing 300 includes a second portion 320 that supports the inertial sensor module 600.

The first portion 310 is provided with a first opening hole 311 through which the sensor substrate 610 of the inertial sensor module 600 passes, in other words, into which the sensor substrate 610 is fitted. A rib 312 for improving the stiffness of the first portion 310, particularly in the periphery of the first opening hole 311, is disposed around the first opening hole 311.

The rib 312 is provided with screw holes 313 for fixing the first portion 310 and the second portion 320 together. The second portion 320 is provided with fixing screws 321 as bolts which are screwed into the screw holes 313. When the second portion 320 is fixed to the first portion 310 by using the screw holes 313 and the fixing screws 321, the sensor substrate 610 of the second portion 320 is disposed in the first opening hole 311 of the first portion 310.

Support columns 322 are disposed in the second portion 320 at the four corners of the sensor substrate 610. To be specific, the support columns 322 are disposed between the sensor substrate 610 and a base portion 320a. In other words, the sensor substrate 610 is disposed at a position away upward, that is, in the +Z direction from the base portion 320a by the length of the support columns 322.

In this way, since the rib 312 is provided around the first opening hole 311, the stiffness around the first opening hole 311 can be improved. In addition, since the first portion 310 and the second portion 320 are separated from each other and the inertial sensor module 600 is fixed to the second portion 320, it is possible to prevent the vibration from the vibration source from being directly transmitted to the inertial sensor module 600. Further, since the sensor substrate 610 is disposed at a position away from the base portion 320a via the four support columns 322, it is possible to suppress the vibration transmitted to the inertial sensor module 600.

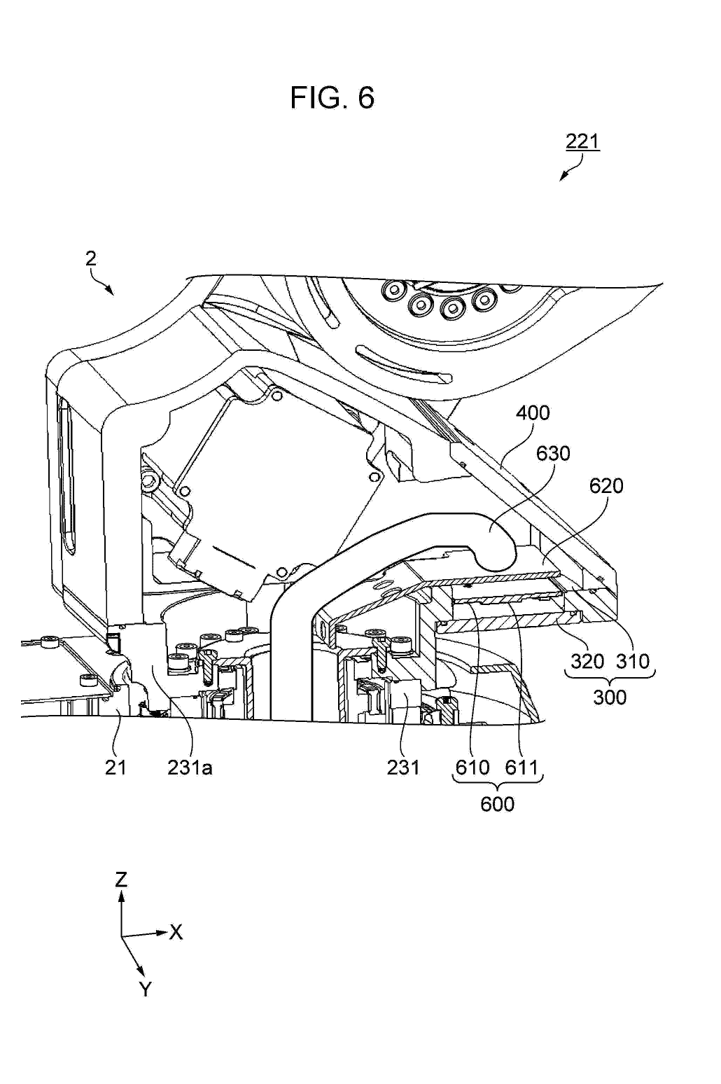

Next, the internal structure of the first arm 221 will be described with reference to FIG. 6.

As illustrated in FIG. 6, the first arm 221 includes the first housing 300 and the second housing 400. As described above, the first housing 300 includes the first portion 310 and the second portion 320 disposed in the first opening hole 311 of the first portion 310.

The inertial sensor module 600 is fixed to the second portion 320 such that the angular velocity sensor 611 is located below the sensor substrate 610. A cover 620 is disposed above the sensor substrate 610 so as to cover the sensor substrate 610.

The cable 630 including a power supply line and a signal line is disposed inside the robot main body 2, specifically, for example, from the inside of the base 21 to the inside of the first arm 221. The cover 620 is provided so that the cable 630 does not come into contact with the sensor substrate 610 when the cable 630 is moved along with the operation of the robot main body 2.

In this manner, since the cover 620 is disposed so as to cover the sensor substrate 610, it is possible to prevent the cable 630 and the like disposed around the sensor substrate 610 from coming into contact with the sensor substrate 610, that is, the inertial sensor module 600, particularly, the angular velocity sensor 611. Therefore, it is possible to improve the detection accuracy of the inertial sensor module 600. In addition, since the inertial sensor module 600 is fixed such that the angular velocity sensor 611 is located below the sensor substrate 610, it is possible to prevent the cable 630 or the like from coming into contact with the angular velocity sensor 611.

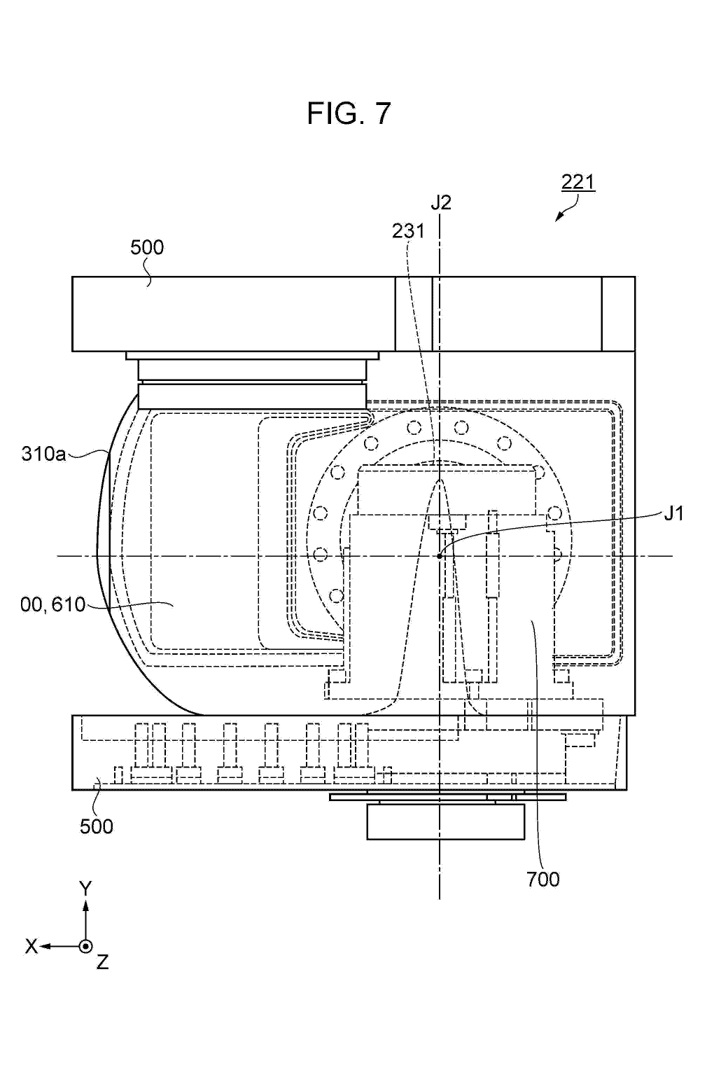

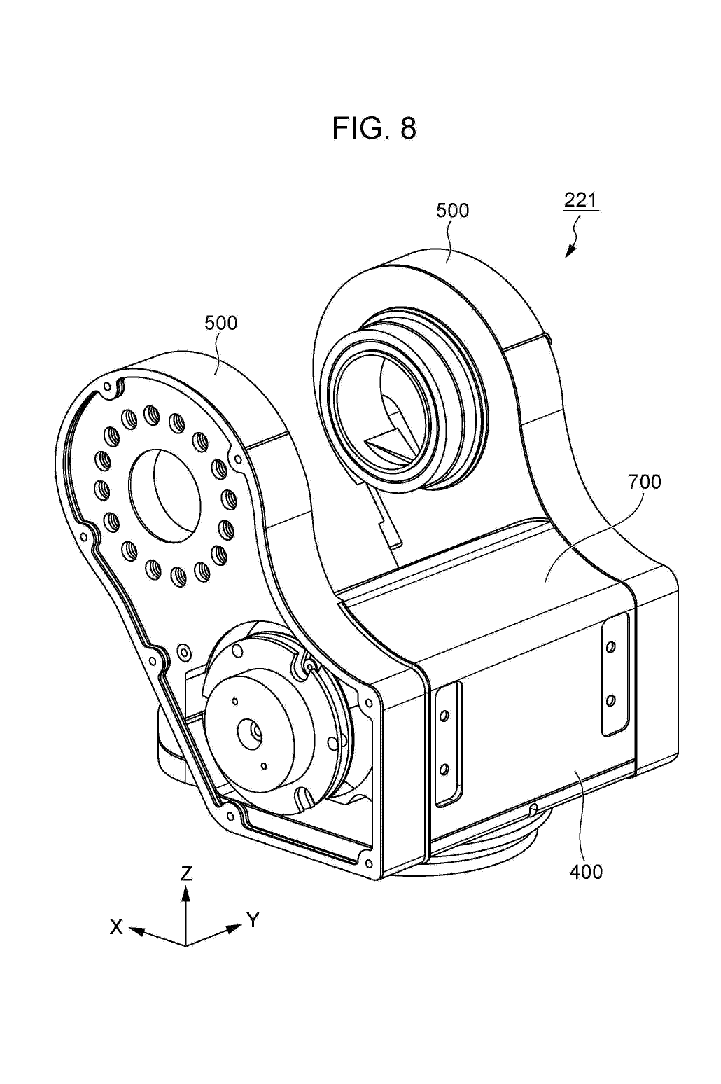

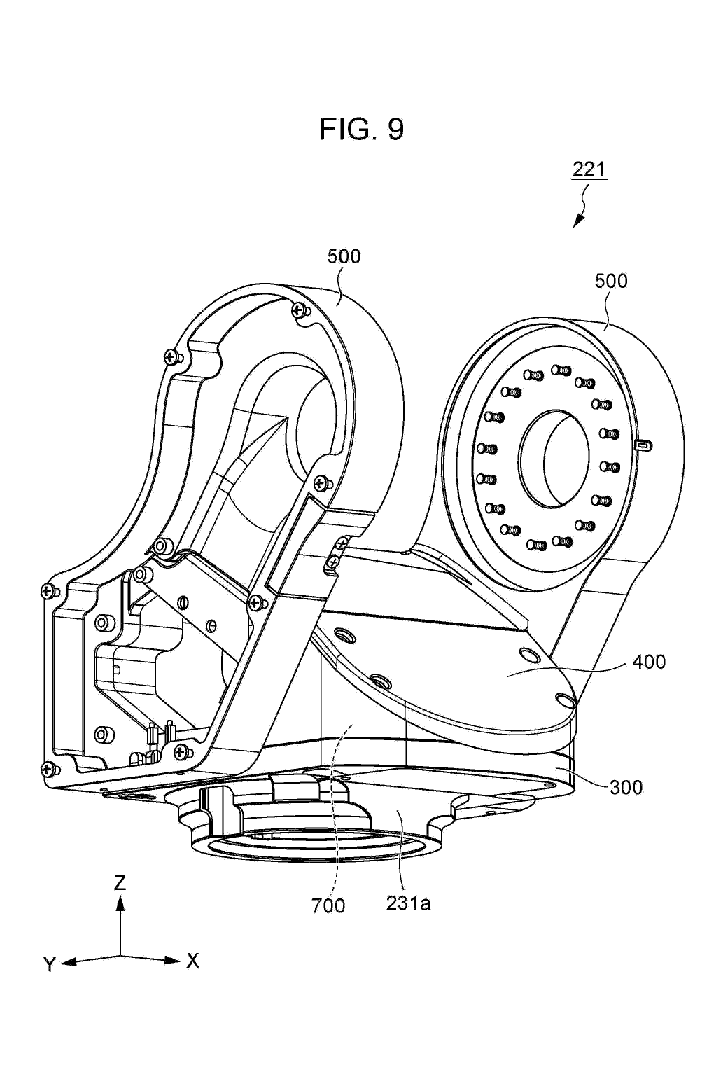

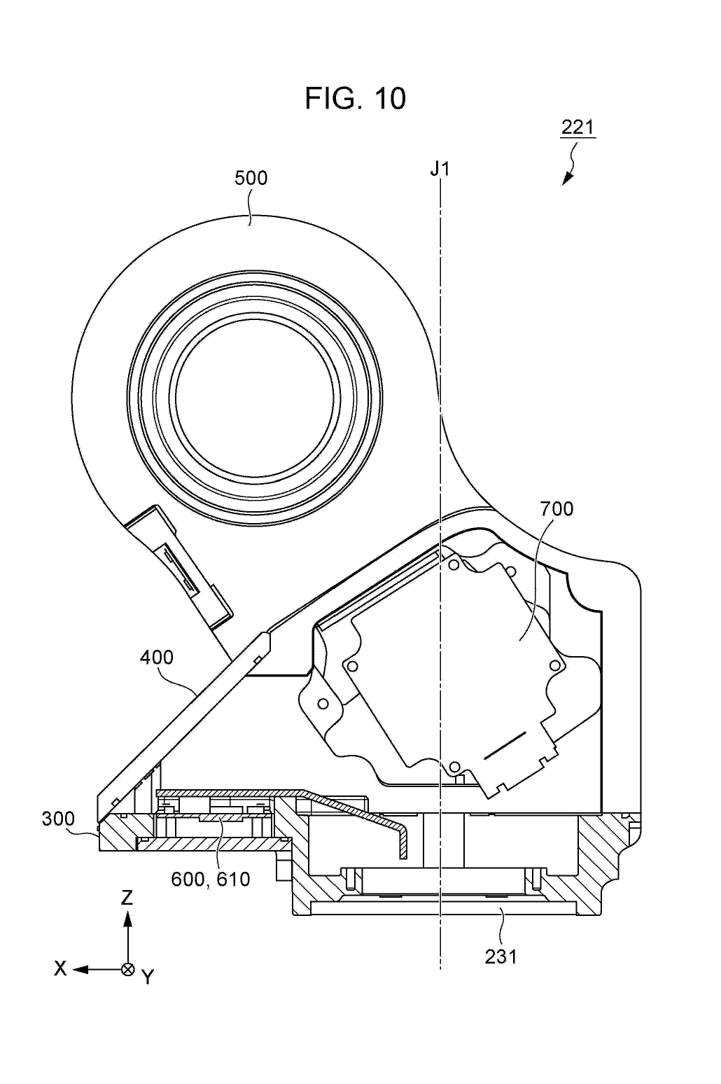

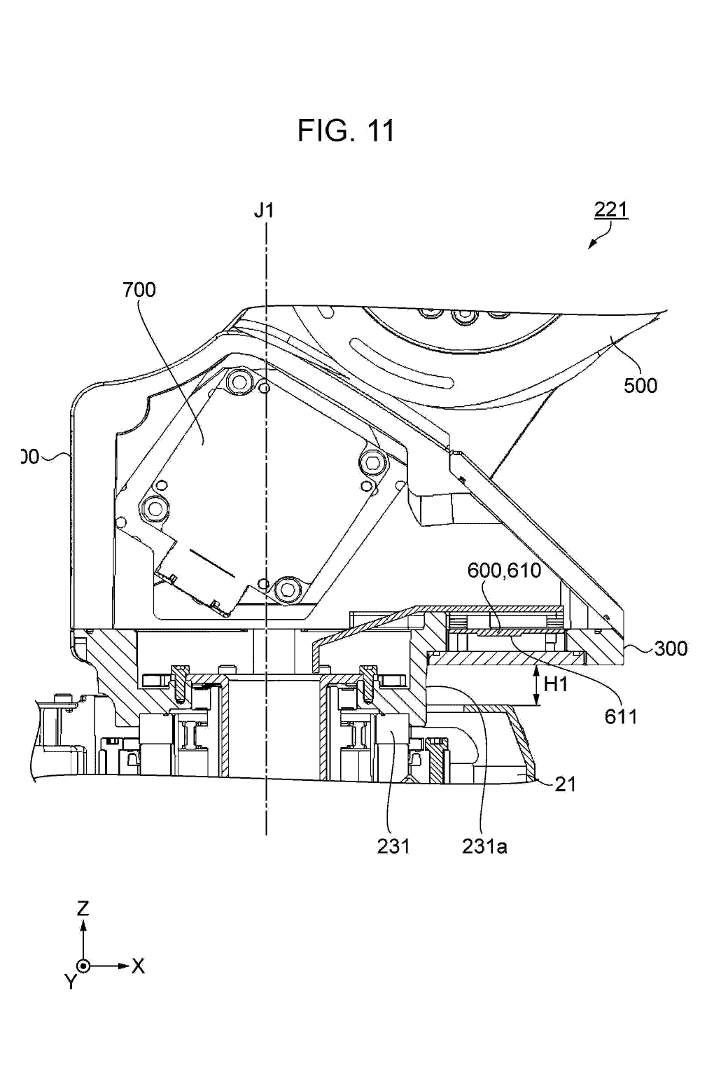

Next, the configuration of the first arm 221 will be described with reference to FIGS. 7 to 11. FIG. 7 is a plan view of the first arm 221, including a transparent view from above. FIGS. 8 and 9 are perspective views illustrating the internal structure of the first arm 221, mainly the support portions 500. FIGS. 10 and 11 are cross-sectional views illustrating the internal structure of the first arm 221, mainly the first housing 300 and the second housing 400.

As illustrated in FIGS. 8 and 9, the first arm 221 includes the first housing 300 and the second housing 400. The second housing 400 has the support portions 500, and the support portions 500 include two support portions 510 and 520 (refer to FIG. 3) located on both sides of the first housing 300 and the second housing 400. The motor 700 that drives the second arm 222 is disposed inside the second housing 400.

As described above, the first arm 221 is connected to the second drive mechanism 232 (refer to FIG. 2). The second drive mechanism 232 includes a speed reducer and a pulley provided on an input shaft of the speed reducer. The pulley of the second drive mechanism 232 and the motor 700 are connected via a belt 530 (refer to FIG. 3). The belt 530 is arranged in a support portion 500.

In this manner, since the second drive mechanism 232 and the motor 700 are connected to each other via the belt 530, vibration is likely to occur. However, since the inertial sensor module 600 is fixed to the first housing 300, and the inertial sensor module 600 and the vibration sources (the motor 700 and the belt 530 which can be vibration sources) are not directly connected to each other, it is possible to prevent transmission of vibration to the inertial sensor module 600.

As illustrated in FIGS. 7, 10, and 11, the first arm 221 includes the first housing 300 and the second housing 400. The first arm 221 is connected to the base 21 via the first drive mechanism 231. As described above, the first drive mechanism 231 rotates the first arm 221 about the rotation axis J1 with respect to the base 21.

The motor 700 is disposed on the rotation axis J1 in the second housing 400. In this manner, since the motor 700 is disposed on the rotation axis J1, it is possible to reduce the influence of the inertia, that is, the moment of inertia of the motor 700 when the motor 700 rotates about the rotation axis J1. Therefore, it is possible to prevent the vibration from being transmitted to the inertial sensor module 600.

The first arm 221 includes the two support portions 500, specifically, the first support portion 510 and the second support portion 520. As illustrated in FIG. 7, the inertial sensor module 600 and the sensor substrate 610 are disposed between the first support portion 510 and the second support portion 520 (refer to FIG. 3) in a plan view.

To be specific, as illustrated in FIGS. 5 and 7, the first housing 300 has a protruding portion 310a that protrudes from a portion overlapping the first drive mechanism 231 in a plan view toward the periphery, to be specific, in the +X direction. The inertial sensor module 600 and the sensor substrate 610 are disposed in the protruding portion 310a. That is, the inertial sensor module 600 is disposed so as not to overlap the motor 700 and the two support portions 500 in the vertical and horizontal directions, that is, in the X direction, the Y direction, and the Z direction. In other words, the inertial sensor module 600 is not disposed vertically below the motor 700 which is a vibration source.

In this manner, since the inertial sensor module 600 is disposed between the two support portions 510 and 520 and in the protruding portion 310a of the first housing 300, it is possible to position the inertial sensor module 600 away from the vibration sources, to be specific, the motor 700, the belt 530, and the like, and it is possible to prevent the vibration from being transmitted to the inertial sensor module 600.

As illustrated in FIGS. 9 and 11, the first arm 221 is connected to the first drive mechanism 231. The first housing 300 has a cylindrical flange portion 231a extending parallel to the rotation axis J1. In other words, the first housing 300 has the flange portion 231a adjacent to the base 21. The flange portion 231a is connected to the output side of the hollow speed reducer of the first drive mechanism 231 disposed in the base 21.

In this way, since the first housing 300 is connected to the base 21 via the flange portion 231a, the first housing 300 and the base 21 can be away from each other by the length H1 (refer to FIG. 11) of the flange portion 231a. Therefore, it is possible to prevent the first housing 300 from interfering with the base 21, and to prevent the noise due to the interference from being transmitted to the inertial sensor module 600.

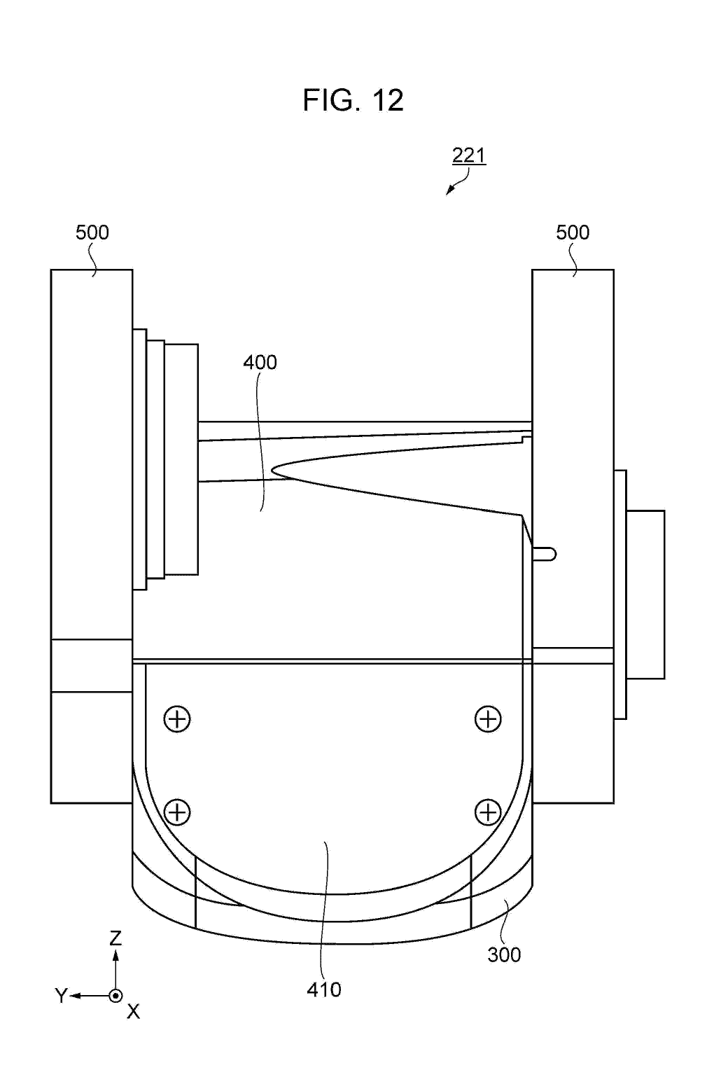

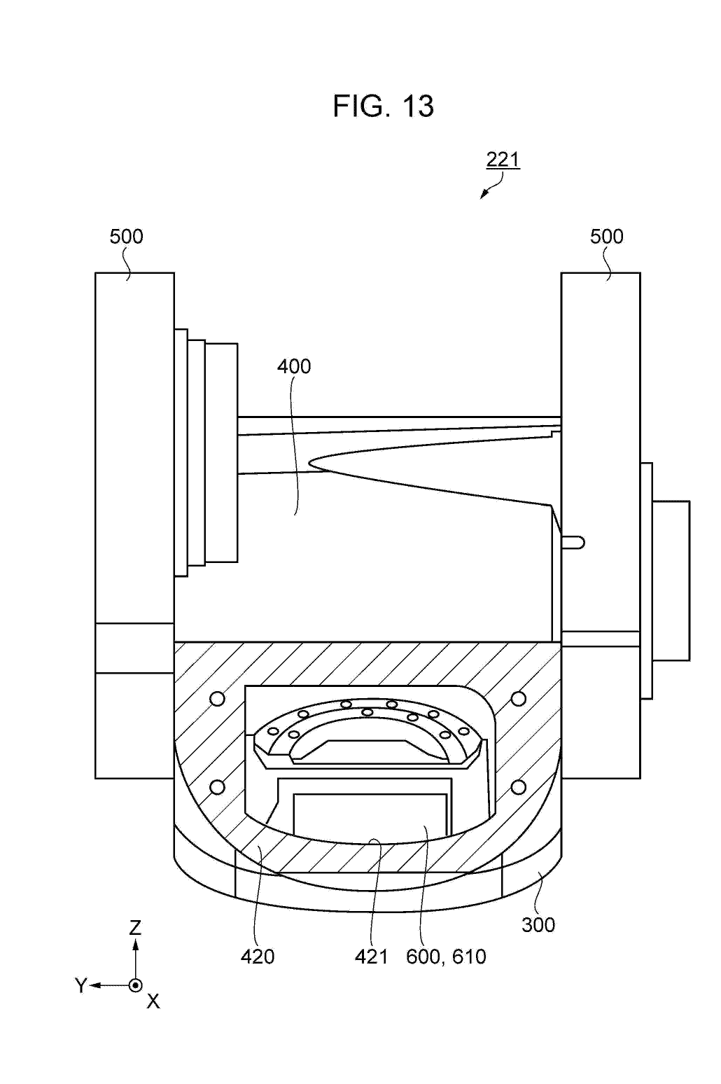

Next, a maintenance method for the inertial sensor module 600 and the sensor substrate 610 will be described with reference to FIGS. 12 and 13.

As illustrated in FIG. 12, the first arm 221 includes the first housing 300 and the second housing 400. The second housing 400 includes a cover 410 disposed at a position overlapping at least the sensor substrate 610 in a plan view and above the sensor substrate 610, that is, on the opposite side of the sensor substrate 610 from the second portion. The cover 410 is detachably provided by using fixing members such as screws.

As illustrated in FIG. 13, the second housing 400 includes a cover support portion 420 disposed below the cover 410 and provided with a second opening hole 421. The second opening hole 421 is provided in a region overlapping the inertial sensor module 600 and the sensor substrate 610 in a plan view.

In this manner, since the second opening hole 421 is provided in the first arm 221, it is possible to perform maintenance on the inertial sensor module 600 and the sensor substrate 610 from the outside without disassembling the first arm 221, that is, the first housing 300 or the second housing 400. In addition, since the second opening hole 421 is closed by the cover 410 except during maintenance, it is possible to prevent a decrease in stiffness and to prevent the entry of foreign matter or the like.

As described above, the vertical articulated robot 1 of the present embodiment includes the base 21, the first drive mechanism 231 connected to the base 21, the first arm 221 connected to the first drive mechanism 231 and configured to rotate about the rotation axis J1, the second drive mechanism 232 connected to the first arm 221, the second arm 222 connected to the second drive mechanism 232, and the motor 700 configured to drive the second arm 222, the first arm 221 includes the first housing 300 connected to the first drive mechanism 231 and the second housing 400 fixed to the first housing 300 and connected to the second drive mechanism 232, and the inertial sensor module 600 fixed to the first housing 300 and configured to detect at least one parameter selected from the acceleration and the angular velocity of the first arm 221, and the motor 700 is fixed to the second housing 400 or the second arm 222.

According to this configuration, since the inertial sensor module 600 is fixed to the first housing 300 and the motor 700 is fixed to the second housing 400 or the second arm 222, the inertial sensor module 600 and the motor 700 which is a vibration source are not fixed to the same housing. Therefore, it is possible to prevent the vibration of the motor 700 from being directly transmitted to the inertial sensor module 600, and to suppress the influence of the vibration. Thus, it is possible to improve the detection accuracy of the inertial sensor module 600.

In addition, since the first arm 221 is divided into the first housing 300 and the second housing 400, it is possible to suppress the vibration transmitted to the inertial sensor module 600. Therefore, it is not necessary to provide a vibration suppression member such as an anti-vibration rubber between the first housing 300 and the second housing 400, and it is possible to simplify the configuration. However, an anti-vibration rubber or the like may be disposed between the first housing 300 and the second housing 400.

In the vertical articulated robot 1 according to the present embodiment, it is preferable that the second drive mechanism 232 and the motor 700 are connected to each other via the belt 530. According to this configuration, since the second drive mechanism 232 and the motor 700 are connected to each other via the belt 530, vibration is likely to occur. However, since the inertial sensor module 600 is fixed to the first housing 300, and the inertial sensor module 600 and the vibration source are not directly connected to each other, it is possible to prevent transmission of the vibration to the inertial sensor module 600.

In addition, in the vertical articulated robot 1 of the present embodiment, it is preferable that the first housing 300 has the first portion 310 connected to the second housing 400 and the second portion 320 to which the inertial sensor module 600 is fixed. According to this configuration, the first housing 300 is divided into the first portion 310 and the second portion 320, and the inertial sensor module 600 is disposed in the second portion 320. Therefore, it is possible to further prevent the vibration from the vibration source from being directly transmitted to the inertial sensor module 600, and to improve the detection accuracy of the inertial sensor module 600.

In the vertical articulated robot 1 of the present embodiment, it is preferable that the first portion 310 is provided with the first opening hole 311 into which the sensor substrate 610 is fitted, that the rib 312 is provided around the first opening hole 311, and that the second portion 320 is fixed to the first portion 310 by inserting the fixing screws 321 fixed to the second portion 320 into the screw holes 313 provided in the rib 312. According to this configuration, since the rib 312 is provided around the first opening hole 311, it is possible to improve the stiffness around the first opening hole 311, and it is possible to make it difficult for vibration to be transmitted. In addition, since the first portion 310 and the second portion 320 are separated from each other with the fixing screws 321 interposed therebetween, it is possible to prevent the vibration from the vibration sources from being transmitted to the inertial sensor module 600.

In the vertical articulated robot 1 according to the present embodiment, it is preferable that the cover 620 covering the sensor substrate 610 is disposed above the sensor substrate 610. According to this configuration, since the cover 620 is disposed, it is possible to prevent the cable 630 and the like disposed around the sensor substrate 610 from coming into contact with the sensor substrate 610, specifically, the inertial sensor module 600. Therefore, it is possible to improve the detection accuracy of the inertial sensor module 600.

Further, in the vertical articulated robot 1 of the present embodiment, it is preferable that the motor 700 is disposed on the rotation axis J1 of the first drive mechanism 231. According to this configuration, since the motor 700 is disposed on the rotation axis J1, it is possible to reduce the inertia, that is, the moment of inertia of the motor 700 when the motor 700 rotates about the rotation axis J1. Therefore, it is possible to prevent the vibration from being transmitted to the inertial sensor module 600.

In addition, in the vertical articulated robot 1 of the present embodiment, it is preferable that the second housing 400 has the two support portions 500 which support the second arm 222, and that the inertial sensor module 600 is disposed between the two support portions 500. According to this configuration, since the inertial sensor module 600 is disposed between the two support portions 500, it is possible to prevent the vibration transmitted from the second arm 222 through the support portions 500 from reaching the inertial sensor module 600.

In addition, in the vertical articulated robot 1 of the present embodiment, it is preferable that the first housing 300 has the protruding portion 310a protruding from a portion overlapping the first drive mechanism 231 in a plan view toward the periphery, and that the inertial sensor module 600 is disposed in the protruding portion 310a. According to this configuration, since the inertial sensor module 600 is disposed in the protruding portion 310a of the first housing 300, it is possible to position the inertial sensor module 600 away from the vibration sources, to be specific, the motor 700, the belt 530, and the like, and it is possible to prevent the vibration from being transmitted to the inertial sensor module 600.

Further, in the vertical articulated robot 1 of the present embodiment, it is preferable that the first housing 300 has the cylindrical flange portion 231a, and that the flange portion 231a is connected to the first drive mechanism 231 as the first joint disposed on the base 21. According to this configuration, since the first housing 300 is connected to the base 21 via the flange portion 231a, it is possible to position the first housing 300 away from the base 21 by the length of the flange portion 231a. Therefore, it is possible to prevent the inertial sensor module 600 disposed in the first housing 300 from interfering with the base 21, and to prevent noise from being transmitted to the inertial sensor module 600.

Further, in the vertical articulated robot 1 of the present embodiment, it is preferable that the first arm 221 is provided with the second opening hole 421 in a portion overlapping the inertial sensor module 600 in a plan view. According to this configuration, since the second opening hole 421 is provided in the first arm 221, it is possible to perform maintenance on the inertial sensor module 600 from the outside without disassembling the first arm 221, that is, the first housing 300 and the second housing 400.

Further, the robot system 1000 of the present embodiment includes the vertical articulated robot 1 described above and the controller 10 that performs arithmetic processing for the inertial sensor module 600. According to this configuration, it is possible to provide the robot system 1000 including the inertial sensor module 600 with an improved detection accuracy.

The following describes modifications of the embodiment described above.

As described above, the present disclosure is not limited to the configuration in which the base 21 corresponds to the proximal member, the first arm 221 corresponds to the arm, and the second arm 222 corresponds to the distal member, and the following combinations may be employed. In addition, the member where the motor 700 is disposed is not limited to the second housing 400 of the first arm 221, and may also be the second arm 222. The combination in the above-described embodiment is referred to as a first combination.

Specifically, in a second combination, the first arm 221 corresponds to the proximal member, the second arm 222 corresponds to the arm, and the third arm 223 corresponds to the distal member. The second housing of the second arm 222 may correspond to the member where the motor 700 is disposed. Alternatively, the motor 700 may be disposed in the third arm 223.

In a third combination, the second arm 222 corresponds to the proximal member, the third arm 223 corresponds to the arm, and the fourth arm 224 corresponds to the distal member. The second housing of the third arm 223 may correspond to the member where the motor 700 is disposed. Alternatively, the motor 700 may be disposed in the fourth arm 224.

In a fourth combination, the third arm 223 corresponds to the proximal member, the fourth arm 224 corresponds to the arm, and the fifth arm 225 corresponds to the distal member. The second housing of the fourth arm 224 may correspond to the member where the motor 700 is disposed. Alternatively, the motor 700 may be disposed in the fifth arm 225.

In a fifth combination, the fourth arm 224 corresponds to the proximal member, the fifth arm 225 corresponds to the arm, and the sixth arm 226 corresponds to the distal member. The second housing of the fifth arm 225 may correspond to the member where the motor 700 is disposed. Alternatively, the motor 700 may be disposed in the sixth arm 226.

1. A vertical articulated robot comprising:
a proximal member;
a first joint connected to the proximal member;
an arm connected to the first joint and configured to rotate about a first rotation axis;
a second joint connected to the arm;
a distal member connected to the second joint; and
a motor configured to drive the distal member, wherein
the arm includes
a first housing connected to the first joint,
a second housing fixed to the first housing and connected to the second joint, and
an inertial sensor fixed to the first housing and configured to detect at least one parameter selected from acceleration and angular velocity of the arm, and
the motor is fixed to the second housing or the distal member.

2. The vertical articulated robot according to claim 1, wherein
the second joint and the motor are connected to each other via a belt.

3. The vertical articulated robot according to claim 1, wherein
the first housing includes a first portion connected to the second housing and a second portion to which the inertial sensor is fixed.

4. The vertical articulated robot according to claim 3, wherein
the first portion is provided with a first opening hole into which a sensor substrate is fitted,
a rib is provided around the first opening hole, and
the second portion is fixed to the first portion by inserting a bolt fixed to the second portion into a screw hole provided in the rib.

5. The vertical articulated robot according to claim 3, wherein
a cover covering the sensor substrate is disposed above the sensor substrate.

6. The vertical articulated robot according to claim 1, wherein
the motor is disposed on the first rotation axis of the first joint.

7. The vertical articulated robot according to claim 1, wherein
the second housing includes two support portions that support the distal member, and
the inertial sensor is disposed between the two support portions.

8. The vertical articulated robot according to claim 1, wherein
the first housing includes a protruding portion protruding from a portion overlapping the first joint in a plan view toward a periphery, and
the inertial sensor is disposed in the protruding portion.

9. The vertical articulated robot according to claim 1, wherein
the first housing has a cylindrical flange portion extending parallel to the first rotation axis, and the flange portion is connected to the first joint disposed on the proximal member.

10. The vertical articulated robot according to claim 1, wherein
the arm is provided with a second opening hole in a portion overlapping the inertial sensor in a plan view.

11. A robot system comprising:
the vertical articulated robot according to claim 1; and
a control device that performs arithmetic processing for the inertial sensor.
